(19) United States
(12) Patent Application Publication
(10) Pub. No.: US 2022/0308269 A1
(43) Pub. Date: Sep. 29, 2022

(54) Color Filter Substrate, Manufacturing Method Thereof, Display Panel and Display Device

(71) Applicants: Ordos Yuansheng Optoelectronics Co., Ltd., Ordos, Inner Mongolia (CN); BOE Technology Group Co., Ltd., Beijing (CN)

(72) Inventors: Feng YANG, Beijing (CN); Yezhou FANG, Beijing (CN); Qiang CHEN, Beijing (CN); Xiaojin LI, Beijing (CN); Fang ZHU, Beijing (CN)

(21) Appl. No.: 17/286,824

(22) PCT Filed: Jan. 8, 2021
(86) PCT No.: PCT/CN2021/070932

§ 371 Date: Apr. 20, 2021

(30) Foreign Application Priority Data
Jan. 22, 2020 (CN) 202010075121.8

(51) Int. Cl. G02B 5/00

(52) U.S. Cl. CPC G02B 5/003

(57) ABSTRACT

A color filter substrate, a manufacturing method thereof, a display panel and a display device are provided. The color filter substrate includes a substrate; and a black matrix arranged on the substrate, wherein the black matrix includes a first shading strip extending along a sub-pixel length direction and a second shading strip extending along a sub-pixel width direction, and the first shading strip is made of a metal material.

The present application claims the priority of Chinese patent application No. 202010075121.8, filed to the CNIPA on Jan. 22, 2020 and entitled “Display Substrate, Manufacturing Method Thereof, Display Panel and Display Device”, the content of which should be regarded as being incorporated to the present application herein by reference.

### TECHNICAL FIELD

The disclosure relates to, but is not limited to, the technical field of display, in particular to a color filter substrate, a manufacturing method thereof, a display panel and a display device.

### BACKGROUND

The vertical black matrix range of traditional Mobile products is 4˜5 μm, and the horizontal black matrix width range of traditional Mobile products is 13˜15 μm (micron). With the improvement of the resolution requirement of the display device, the density of each color resistor in the color filter substrate is getting higher and higher, so the requirement of the black matrix width between adjacent color resistors is getting narrower and narrower. VR products require the vertical black matrix width to be 3˜4 μm, and the horizontal black matrix width also needs to be compressed. Ultra-high PPI products (usually refer to display devices with PPI>1200) will have higher requirements for Black Matrix Critical Dimension (BM CD) compression. However, due to the constraints of BM materials and process, BM CD cannot be reduced unlimitedly. In addition, at present, when the BM CD of VR products reaches 3.5 μm, BM burrs or burr edges are generated at the edges of the color resistors, which affects the picture quality of the products.

### SUMMARY

The following is a summary of the subject matter described in detail in the present disclosure. This summary is not intended to limit the protection scope of the claims.

The present disclosure provides a color filter substrate, including: a substrate; and a black matrix arranged on the substrate. The black matrix includes a first shading strip extending along a sub-pixel length direction and a second shading strip extending along a sub-pixel width direction, and the first shading strip is made of metal material.

In an exemplary embodiment, the second shading strip is made of organic material.

In an exemplary embodiment, the color filter substrate further comprises an edge shading strip. The edge shading strip is arranged on a same layer as the first shading strip, and a material of the edge shading strip is same as the material of the first shading strip. The edge shading strip extends along the sub-pixel width direction and is connected with each first shading strip.

In an exemplary embodiment, the edge shading strip is connected with a ground wire.

In an exemplary embodiment, the second shading strip is made of a same material as the first shading strip.

In an exemplary embodiment, the metal material is molybdenum.

The present disclosure also provides a manufacturing method for a color filter substrate, including: forming a pattern of a first shading strip extending along a pixel length direction on a substrate, wherein the first shading strip is made of a metal material; forming a pattern of a second shading strip extending along a pixel width direction on the first shading strip, wherein the second shading strip is made of an organic material; and forming a color resistor in a pixel area in an array arrangement formed by the first shading strip and the second shading strip.

The present disclosure also provides a manufacturing method for a color filter substrate, including:

forming a pattern of a second shading strip extending along a pixel width direction on a substrate, wherein the second shading strip is made of an organic material; forming a pattern of a first shading strip extending along a pixel length direction on the second shading strip, wherein the first shading strip is made of a metal material; and forming a color resistor is in a pixel area in an array arrangement formed by the first shading strip and the second shading strip.

The present disclosure also provides a display panel including any of the above color filter substrates.

The present disclosure further provides a display device, including any of the above display panels.

Other aspects will become apparent upon reading and understanding accompanying drawings and the detailed description.

### BRIEF DESCRIPTION OF DRAWINGS

Other features, objects and advantages of the present disclosure will become more apparent by reading the detailed description of non-limiting embodiments made with reference to the following drawings:

FIG. 1 shows an exemplary structural block diagram of a traditional color filter substrate.

FIG. 2 shows an exemplary structural block diagram of a color filter substrate according to an embodiment of the present disclosure.

FIG. 3 shows an exemplary structural block diagram of a color filter substrate according to another embodiment of the present disclosure.

FIG. 4 shows an exemplary flow chart of a manufacturing method for the color film substrate of FIG. 2.

FIG. 5 to FIG. 7 show specific exemplary schematic diagrams of the manufacturing method of the color filter substrate according to FIG. 4.

FIG. 8 is an exemplary schematic diagram of a black matrix of a traditional color filter substrate.

FIG. 9 is an exemplary schematic diagram of edge morphology of a black matrix in a traditional color filter substrate.

FIG. 10 is an exemplary schematic diagram of edge morphology of a black matrix in a color filter substrate according to an embodiment of the present disclosure.

### DETAILED DESCRIPTION

The following is a further detailed description of the present disclosure with reference to the drawings and embodiments. It can be understood that the specific embodiments described herein are only used to explain the disclosure, and not to limit the disclosure. In an exemplary embodiment, for convenience of description, only the parts related to the disclosure are shown in the drawings.

Unless otherwise defined, technical terms or scientific terms used in the present disclosure shall have the ordinary meaning understood by those with ordinary skills in the art to which the present disclosure pertains. The words “first”, “second” and the like used in the present disclosure do not indicate any order, quantity or importance, but are only used to distinguish different components. Words such as “comprising”, “including”, or the like, mean that the elements or articles preceding the word cover elements or articles listed after the word and their equivalents, and do not exclude other elements or articles. Similar words such as “connect” or “link” are not limited to physical or mechanical connections, but may include electrical connections, whether direct or indirect. “Up”, “down”, “left”, “right” and the like are merely used to indicate a relative positional relationship. Upon the change of an absolute position of a described object, the relative positional relationship may also change accordingly.

The embodiments and features in the embodiments in the present disclosure may be combined randomly if there is no conflict. Hereinafter, the present disclosure will be described in detail with reference to the drawings and in combination with embodiments.

With the development of ultra-high PPI display, higher requirements are put forward for color filter substrates. However, in a traditional color filter substrate, the width of the black matrix cannot be unlimitedly reduced due to the material of the black matrix and process constraints. Especially for VR products, when the BM CD of the color filter substrate is 3.5 μm, it is easy to cause the problem of substandard BM appearance, which seriously affects the picture quality of products. FIG. 1 is a schematic diagram of a traditional color filter substrate, wherein a first shading strip and a second shading strip are both made of organic materials, and a limit width of a line width of a black matrix made of traditional organic materials is close to 3.5 μm.

The present disclosure proposes the following improvements.

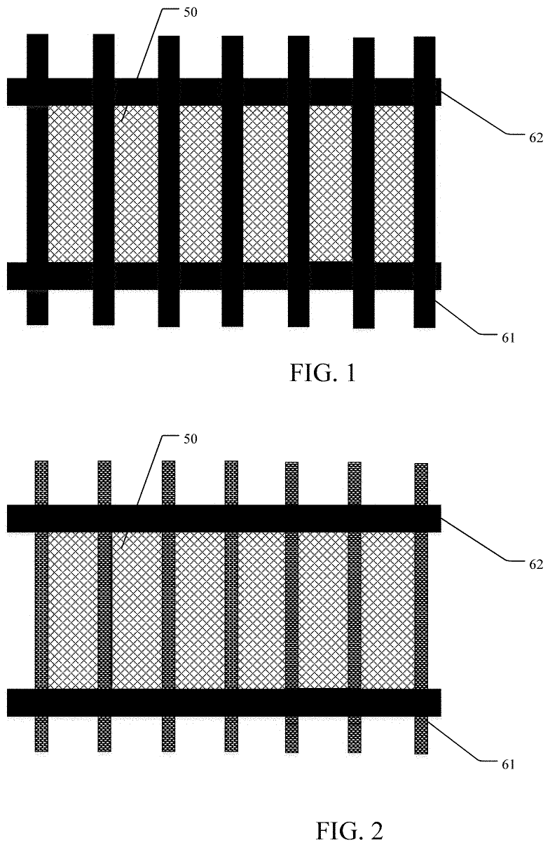

Referring to FIG. 2, the present disclosure provides a color filter substrate, which includes a substrate and a black matrix arranged on the substrate. The black matrix includes a first shading strip 61 extending along a sub-pixel length direction and a second shading strip 62 extending along a sub-pixel width direction. The first shading strip 61 is made of a metal material.

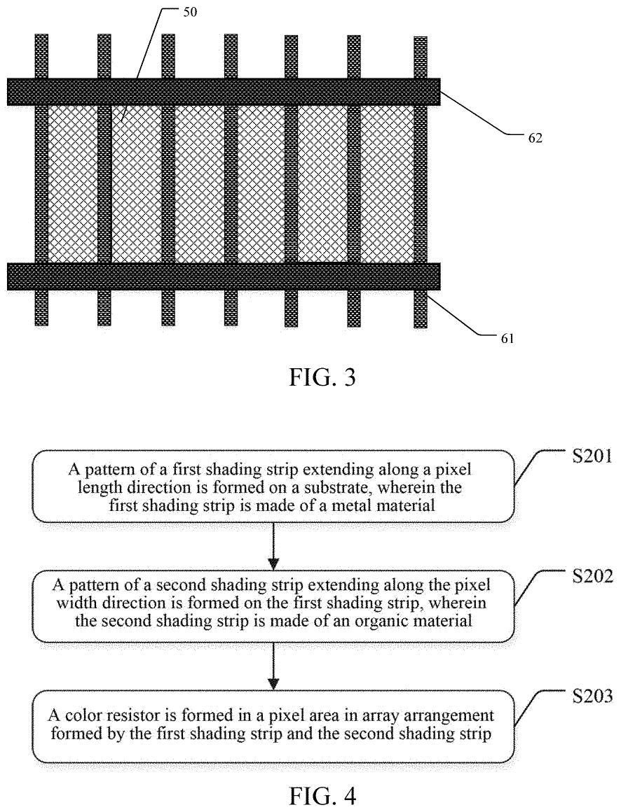

In an exemplary embodiment, the color filter substrate may also include a color resistor 50, as shown in FIG. 2 and FIG. 3.

After the first shading strip 61 of the black matrix of the color filter substrate is made of a metal material, the line width CD of the first shading strip can be made to 2 μm, which can fully reduce the line width of first shading strip made of the existing organic material. And it is beneficial to achieve ultra-high PPI display.

In some exemplary embodiments, the metal material may be molybdenum Mo, but is not limited to molybdenum. And other metal materials may also be used. For example, in the case of a thickness of 2800 Å, a metal material with an optical density (OD, for characterizing a shading ability of the material) greater than 4 may be considered for use in the first shading strip, such as molybdenum or chromium. In an exemplary embodiment, given thickness values and optical density values are only reference values and may be adjusted according to specific application scenarios.

In some exemplary embodiments, the first shading strip is made of a pure metal, and the line width CD of the first shading strip may reach 2 μm. The metal material is molybdenum.

When the first shading strip is made of the metal material, the second shading strip may be made of a same material as the first shading strip, as shown in FIG. 3. The first shading strip and the second shading strip are both made of metal, forming a mesh connection. At this time, an anti-static performance of the color filter substrate may be improved by connecting any one shading strip with a ground wire.

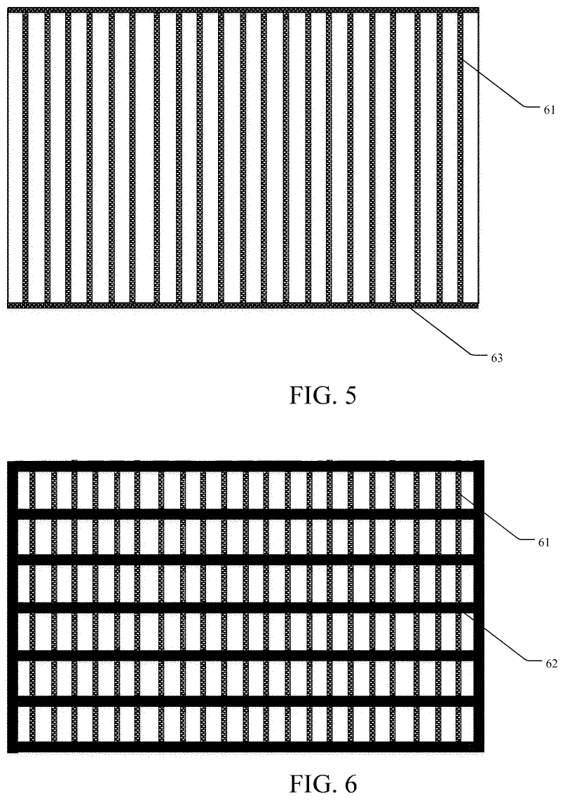

Or, the second shading strip is made of a traditional organic material, as shown in FIG. 2. In ultra-high PPI display, the requirements for the second shading strip have not reached the limit of traditional black matrix materials, and the second shading strip may still be made of traditional organic materials. At this time, the color filter substrate also includes an edge shading strip 63, wherein the edge shading strip 63 is arranged on a same layer as the first shading strip and made of the same material as the first shading strip. The edge shading strip extends along a sub-pixel width direction and is connected with each first shading strip 61, as shown in FIG. 5. The edge shading strip may be grounded to form an effective static electricity leading-out channel, thus obviously improving the anti-static performance of the color filter substrate.

Whether the second shading strip is made of the same material as the first shading strip is determined according to the specific application scenario, which is not limited here. The present disclosure also provides a manufacturing method for the color filter substrate of FIG. 2.

As shown in FIG. 4, the manufacturing method includes the following steps S201-S203:

In S201, forming a pattern of a first shading strip extending along a pixel length direction on a substrate, wherein the first shading strip is made of a metal material;

In S202, forming a pattern of a second shading strip extending along a pixel width direction on the first shading strip, wherein the second shading strip is made of an organic material; and

In S203: forming a color resistor in a pixel area in array arrangement formed by the first shading strip and the second shading strip.

The following description will be made with reference to FIG. 5 to FIG. 7.

A whole layer of white glass is coated with a metal material by Sputter process, with a thickness of 2800 Å, and an OD value of a shading ability of the metal material is greater than 4. A pattern of a vertical first shading strip is formed by exposure, development and etching, as shown in FIG. 5. In an exemplary embodiment, the formed pattern also includes a pattern of an edge shading strip, and an anti-static performance of the color filter substrate may be improved by connecting the edge shading strip with a ground wire. In an exemplary embodiment, as shown in FIG. 3, when the first shading strip and the second shading strip are both made of the metal material, a mesh black matrix pattern may be obtained by using only one exposure, development and etching process.

On the basis of the substrate shown in FIG. 5, the second shading strip is made of traditional BM material. Firstly, a layer of BM photoresistor is coated on a whole surface of the substrate. After Mask exposure (50±20 mj), development (KHO, 0.05%) and curing, a pattern of a horizontal second shading strip is formed as shown in FIG. 6.

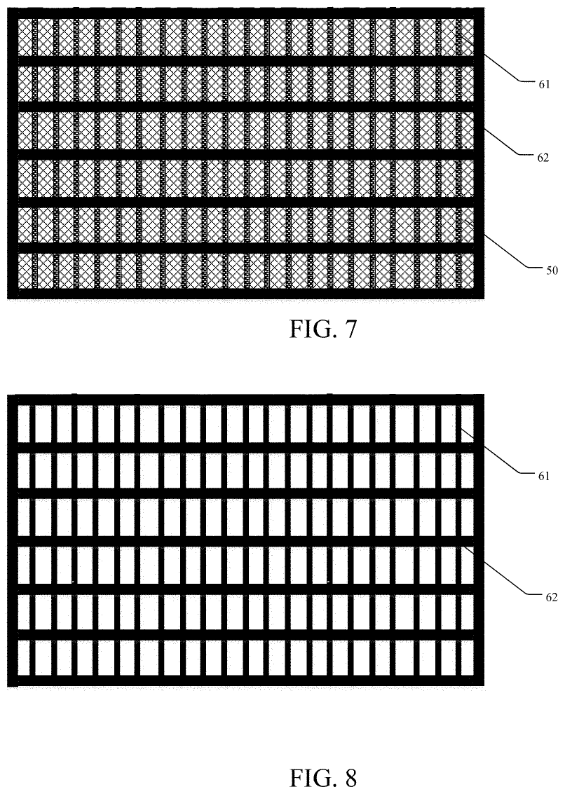

On the basis of the substrate shown in FIG. 6, a required color resistor 50 is formed in a pixel area which is in array arrangement formed by the first shading strip and the second shading strip, as shown in FIG. 7. On this basis, a flat layer and a spacer layer may be prepared to achieve the manufacturing of the required color filter substrate.

In the present disclosure, as shown in FIG. 2, the first shading strip and the second shading strip are made of different materials. Through the manufacturing processes of step S201 and step S202 of forming strip pattern by twice exposure, development and etching processes, effects of significantly increasing a contact area between the black matrix and the developer solution and effectively improving the development residue may be obtained.

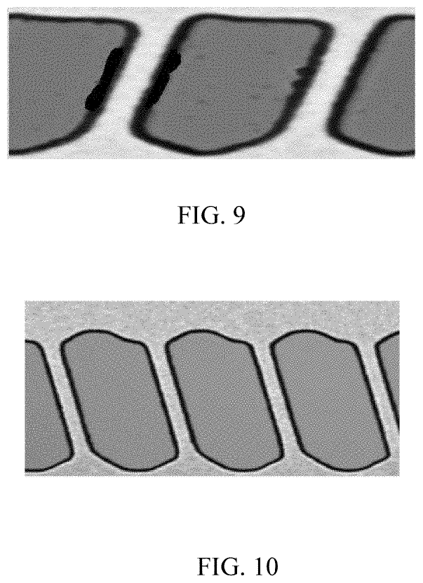

For the color filter substrate as shown in FIG. 1, a mesh interwoven structure formed by the first shading strip and the second shading strip is manufactured by the processes of one exposure, development and etching, as shown in FIG. 8. In the developing process, the effective contact area between the developer and the black matrix pattern is approximately an area of a pixel unit. At this time, in ultra-high PPI display products, a pixel opening area is very small, and due to the influence of a tension of the developing solution, the developing solution cannot sufficiently contact with the black matrix at the edge. So that burrs or burr-like development residues are easily formed at the edge, which makes the edge of the formed black matrix irregular, resulting in the degradation of display quality. At this time, the edge morphology of the black matrix is shown in FIG. 9.

In the manufacturing methods for the black matrix as shown in FIG. 5 and FIG. 6, the black matrix is formed by overlapping the respective strip structures of the first shading strip and the second shading strip, so that the contact area between the developing solution and the edge of the black matrix pattern is sufficiently increased during the development process, so that the edge can be sufficiently developed, thus avoiding the development residue of burr edges or burrs formed at the edge, and obtaining the black matrix with neat edge morphology. The edge morphology of the black matrix formed at this time is shown in FIG. 10.

In addition, in the manufacturing method of the color filter substrate in FIG. 4, step S201 and step S202 can be interchanged, that is, the manufacturing method of the color filter substrate can be as follows:

In S301, forming a pattern of a second shading strip extending along a pixel width direction on a substrate, wherein the second shading strip is made of an organic material;

In S302, forming a pattern of a first shading strip extending along a pixel length direction on the second shading strip, wherein the first shading strip is made of a metal material; and

In S303: forming a color resistor in a pixel area in array arrangement formed by the first shading strip and the second shading strip.

The present disclosure also provides a display panel including the color filter substrate provided by various embodiments of the present disclosure.

The present disclosure also provides a display device, which includes the display panel provided by various embodiments of the present disclosure.

To sum up, according to the technical scheme provided by the embodiment of the present disclosure, the first shading strip extending along the sub-pixel length direction is made of the metal material, which can solve the problem that the width of the traditional first shading strip cannot meet the requirements of the ultra-high PPI display device. Furthermore, according to some embodiments of the present disclosure, the second shading strip extending along the width direction of the sub-pixel is made of the organic material. In this way, the contact area between the black matrix and the developing solution is significantly increased by the process of preparing the first shading strip and the second shading strip respectively, thus effectively improving the picture quality problem caused by the development residue.

The above description is only a description of the preferred embodiments of the present disclosure and the applied technical principles. It should be understood by those skilled in the art that the disclosure scope involved in the present disclosure is not limited to the technical scheme formed by the specific combination of the above technical features, but also covers other technical schemes formed by any combination of the above technical features or their equivalent features without departing from the inventive concept. For example, the technical scheme formed by replacing the above features with the technical features with similar functions disclosed in the present disclosure (but not limited to).

What is claimed is:

1. A color filter substrate, comprising:
a substrate; and
a black matrix arranged on the substrate,
wherein the black matrix comprises a first shading strip extending along a sub-pixel length direction and a second shading strip extending along a sub-pixel width direction, and the first shading strip is made of a metal material.

2. The color filter substrate of claim 1, wherein the second shading strip is made of an organic material.

3. The color filter substrate of claim 2, further comprising an edge shading strip,
wherein the edge shading strip is arranged on a same layer as the first shading strip, a material of the edge shading strip is same as the material of the first shading strip; and
the edge shading strip extends along the sub-pixel width direction and is connected with each first shading strip.

4. The color filter substrate of claim 3, wherein the edge shading strip is connected with a ground wire.

5. The color filter substrate of claim 1, wherein the second shading strip is made of a same material as the first shading strip.

6. The color filter substrate of claim 1, wherein the metal material is molybdenum.

7. A manufacturing method for a color filter substrate, comprising:
forming a pattern of a first shading strip extending along a pixel length direction on a substrate, wherein the first shading strip is made of a metal material;
forming a pattern of a second shading strip extending along a pixel width direction on the first shading strip, wherein the second shading strip is made of an organic material; and
forming a color resistor in a pixel area in array arrangement formed by the first shading strip and the second shading strip.

8. A manufacturing method for a color filter substrate, comprising:
forming a pattern of a second shading strip extending along a pixel width direction on a substrate, wherein the second shading strip is made of an organic material;
forming a pattern of a first shading strip extending along a pixel length direction on the second shading strip, wherein the first shading strip is made of a metal material; and
forming color resistor in a pixel area in array arrangement formed by the first shading strip and the second shading strip.

9. A display panel, comprising the color filter substrate of claim 1.

10. A display device, comprising the display panel of claim 9.
